(19) United States
(12) Patent Application Publication
(10) Pub. No.: US 2016/0127311 A1
(43) Pub. Date: May 5, 2016

(54) RECLAIMING LEASED IP ADDRESSES IN WIRELESS NETWORKS

(71) Applicant: Avaya Inc., Basking Ridge, NJ (US)

(72) Inventors: Vivek L. Atreya, Bangalore (IN); Shashi Hosakere Ankaiah, Bangalore (IN); Umesh Vidyaranyapura Lakshminarayana, Nagar (IN)

(73) Assignee: Avaya Inc., Basking Ridge, NJ (US)

(21) Appl. No.: 14/533,046

(22) Filed: Nov. 4, 2014

(51) Int. Cl. H04L 29/12

(52) U.S. Cl. CPC H04L 61/2076; H04W 84/12

(57) ABSTRACT

Methods, systems and computer readable media for reclaiming DHCP leased IP address from disassociated clients in a WLAN are described.

### TECHNICAL FIELD

Embodiments relate generally to computer networks, and more particularly, to methods, systems and computer readable media for reclaiming dynamic host configuration protocol (DHCP) leased Internet Protocol (IP) addresses from disassociated clients in a wireless local area network (WLAN) deployment or environment.

### BACKGROUND

With the proliferation of mobile devices and increased acceptance of bring your own device (BYOD), the number of clients connecting to networks has increased considerably. Managing the IP address space for the ever-growing amount of devices can be a challenge.

Client devices may use DHCP to acquire IP address. DHCP leases are typically issued to clients for a fixed period of time. When a client leaves a network, the client is supposed to release its IP address by issuing a DHCP release message. Upon receiving this message, the DHCP server adds the IP address to its free address pool.

However, often with wireless networks, and mobile devices such as smartphones and tablets, the address release process does not happen. When a person using such a device moves away from the WLAN network, the device loses connectivity abruptly and does not get a chance to send the DHCP release message. The DHCP server may have no way of knowing that the client is not on the network. The IP address used by the client device will not be freed until its lease expires. When a large number of such clients lock up IP addresses it can lead to a shortage of IP addresses during peak times.

One approach used by some network administrators to address the IP address shortage is to reduce the DHCP lease time. However, this approach can lead to an increase in the number and/or frequency of DHCP broadcast messages flowing in the network. Thus, this approach may not be feasible or desirable in large deployments.

Some DHCP servers permit DHCP lease-time configuration based on device type and VLAN. The idea with this approach being that mobile devices can be allocated shorter lease times. However, with the advent of BYOD, mobile devices may be (or may become) the majority and, thus, this configuration may not provide any significant advantage.

Embodiments were conceived in light of the above mentioned needs, problems and/or limitations, among other things.

### SUMMARY

One or more embodiments can include methods, systems and computer readable media for reclaiming DHCP leased IP address from disassociated clients in a WLAN. In some implementations, the method can include detecting, at a wireless access point, that a client has lost connectivity with the wireless access point, and determining, at the wireless access point, whether the client released its leased IP address. The method can also include transmitting, from the wireless access point to a wireless controller, a message indicating the client has lost connectivity and an indication of whether the client released its leased IP address.

The method can further include starting an IP address reclaim timer at the wireless controller. The method can also include sending an instruction message to a wireless switching point instructing the wireless switching point to send an IP address release message on behalf of the client, when the IP address reclaim timer expires. The method can further include sending, from the wireless switching point, the IP address release message on behalf of the client.

The method can also include stopping the IP address reclaim timer when the client reconnects, before the IP address reclaim timer expires, to the network at a same or different wireless access point than the client was previously connected to. The IP address can include a DHCP leased IP address. The wireless access point can be configured to perform the operations of the wireless switching point mentioned above in place of a wireless switching point.

Some implementations can include a system comprising one or more processors configured to perform operations. The operations can include detecting, at a wireless access point, that a client has lost connectivity with the wireless access point, and determining, at the wireless access point, whether the client released its leased IP address. The operations can also include transmitting, from the wireless access point to a wireless controller, a message indicating the client has lost connectivity and an indication of whether the client released its leased IP address. The operations can further include starting an IP address reclaim timer at the wireless controller. The operations can also include sending an instruction message to a wireless switching point instructing the wireless switching point to send an IP address release message on behalf of the client, when the IP address reclaim timer expires. The operations can further include sending, from the wireless switching point, the IP address release message on behalf of the client.

The operations can also include stopping the IP address reclaim timer when the client reconnects, before the IP address reclaim timer expires, to the network at a same or different wireless access point than the client was previously connected to. The IP address can be a DHCP leased IP address. The wireless access point performs the operations of the wireless switching point.

Some implementations can include a nontransitory computer readable medium having stored thereon software instructions that, when executed by one or more processors, cause the one or more processors to perform operations. The operations can include detecting, at a wireless access point, that a client has lost connectivity with the wireless access point, and determining, at the wireless access point, whether the client released its leased IP address. The operations can also include transmitting, from the wireless access point to a wireless controller, a message indicating the client has lost connectivity and an indication of whether the client released its leased IP address. The operations can further include starting an IP address reclaim timer at the wireless controller. The operations can also include sending an instruction message to a wireless switching point instructing the wireless switching point to send an IP address release message on behalf of the client, when the IP address reclaim timer expires. The operations can further include sending, from the wireless switching point, the IP address release message on behalf of the client.

The operations can also include stopping the IP address reclaim timer when the client reconnects, before the IP address reclaim timer expires, to the network at a same or different wireless access point than the client was previously connected to. The IP address can be a DHCP leased IP address. The wireless access point performs the operations of the wireless switching point.

### BRIEF DESCRIPTION OF THE DRAWINGS

FIG. 1 is a diagram of an example network in accordance with at least one implementation.

FIG. 2 is a flow chart of an example method for reclaiming DHCP leased IP address from disassociated clients in a WLAN in accordance with at least one implementation.

FIG. 3 is a diagram of an example computer system for reclaiming DHCP leased IP address from disassociated clients in a WLAN in accordance with at least one implementation.

### DETAILED DESCRIPTION

In general, some implementations can provide an advantage of reclaiming DHCP leases from disassociated clients without an increase in broadcast DHCP traffic. Also, some implementations may not need separate DHCP policies/VLANs for mobile clients. Further, some implementations can reclaim IP addresses faster when compared to other approaches (e.g., shorter lease times).

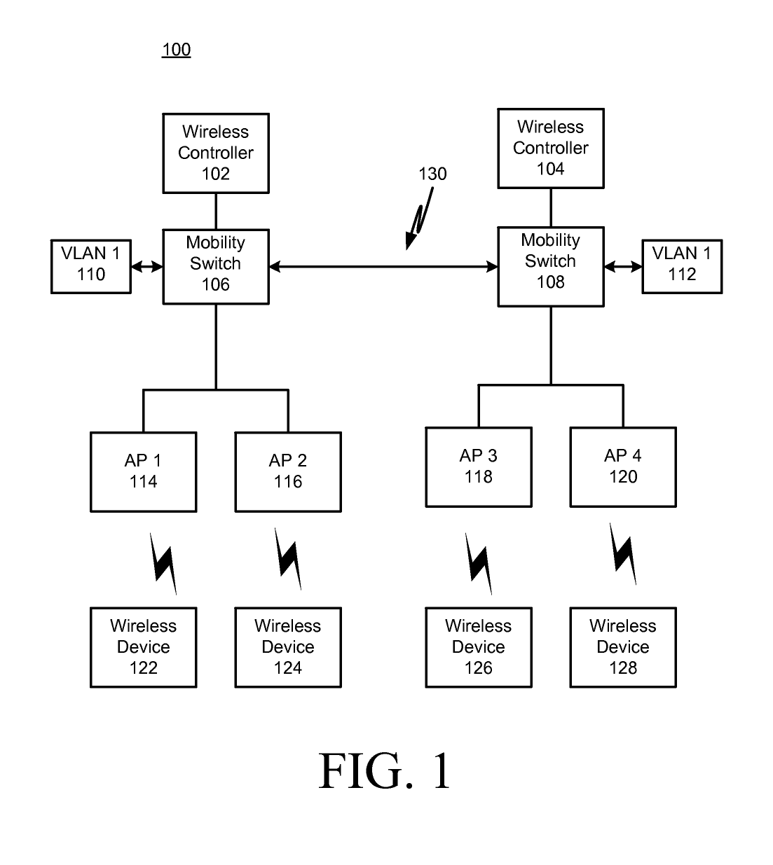

As shown in FIG. 1, an example wireless network 100 (e.g., enterprise WLAN) includes wireless controllers (102 and 104) connected to respective mobility switches (or unified switches) 106 and 108. Each mobility switch (106 and 108) is connected to a respective VLAN (or MVLAN) 110, 112 and serves as the gateway for its corresponding VLAN (there can be more than one mobility switch or unified switch in each VLAN, but only one per VLAN will be designated as the gateway). Access points 114-120 are connected to corresponding unified switches 106, 108. Client devices 122-128 connect to the network via one of the access points 114-120. One or more mobility tunnels 130 connect the mobility switches (106 and 108).

In operation, a WLAN Controller (WC) (e.g., 102 or 104) tracks the state of all (or some) of the clients (e.g., 122-128) in the network 100. When a client disassociates or loses connectivity from the AP (e.g., 114-120), the AP notifies the WC about this change in the client state.

The AP can snoop (or inspect) the client DHCP messages and learns if the client has released its IP address. The AP syncs this information to the WC as a part of the client disassociation message. The WC then starts an IP reclaim timer for the client if the client has disassociated without releasing its IP address. If the client roams to another AP in the network, the WC gets notified by the new AP. The WC then stops the IP reclaim timer for the client.

When the IP reclaim timer for a client times-out or expires, the WC then instructs an AP or wireless switching point (WSP), also referred to as mobility switch, to send a DHCP release message on behalf of the client. The choice of a particular WSP/AP is based on the availability of the client VLAN on that WSP/AP. The WC can send one or more of the following parameters to the chosen WSP/AP: Client IP, Client MAC, DHCP IP, and Transaction ID.

The AP/WSP, upon receiving the message from the controller, frames a DHCP release message using the client address (IP, MAC), and sends it out on the client network. The DHCP server on the network picks up this message and adds the IP address formerly used by the client to its pool of free (or available) IP addresses.

Some implementations can also work in a controller-less WLAN architecture. In a controller-less architecture, the WC function described for this solution will be run by one or more of the APs.

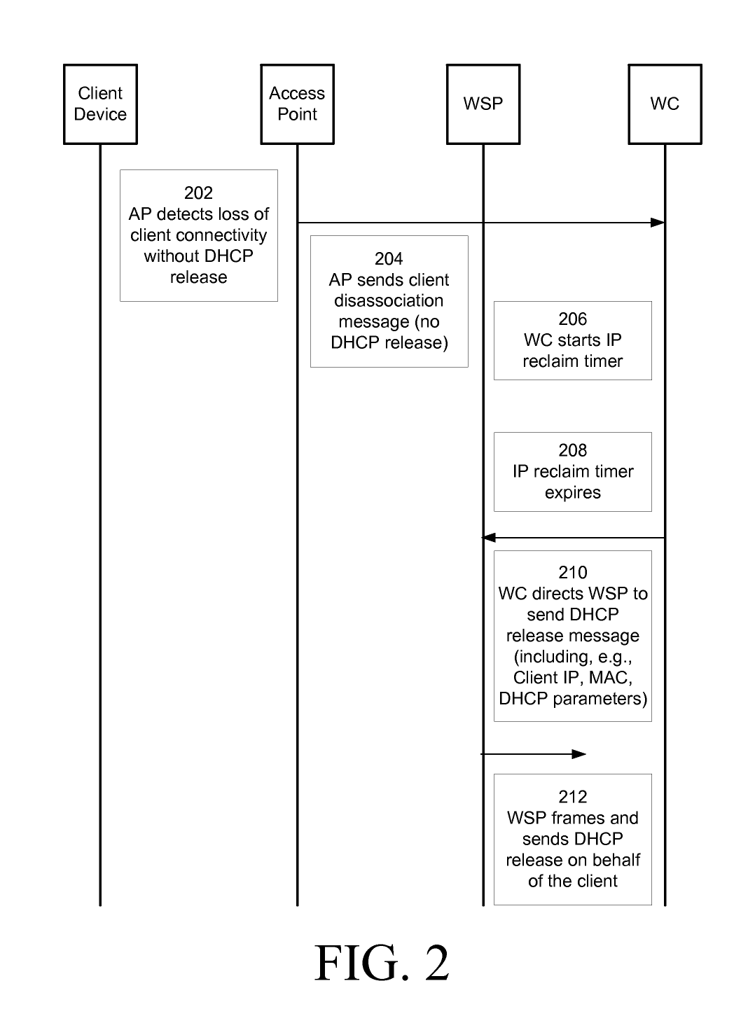

FIG. 2 is a flow chart of an example method for reclaiming DHCP leased IP address from disassociated clients in a WLAN deployment in accordance with at least one implementation. Processing begins at 202, where an access point (e.g., 114-120) detects a loss of client (e.g., 122-128) connectivity or disassociation without DHCP release. For example, the AP can snoop the client DHCP messages to determine if the client has released its IP address. Processing continues to 204.

At 204, the access point sends a message to the WC indicating that the client has disassociated or lost connectivity and indicating whether the client released its IP address. Processing continues to 206.

At 206, for clients that have disassociated or lost connectivity without releasing the IP address, the WC (e.g., 102 or 104) starts an IP address reclaim timer. Processing continues to 208.

At 208, the IP reclaim timer expires because the client did not reconnect to the same AP. Alternatively, if the client roams to another AP in the network, the WC receives notification from the new AP and can then stop the IP reclaim timer for the client. Processing continues to 210.

At 210, the WC instructs a WSP or AP to send a DHCP release message on behalf of the client. Processing continues to 212.

At 212, the WSP (or AP) frames the DHCP release message on behalf of the client and sends it out on the client network. A DHCP on the network can receive the DHCP release message and release the client's IP address back to the free address pool.

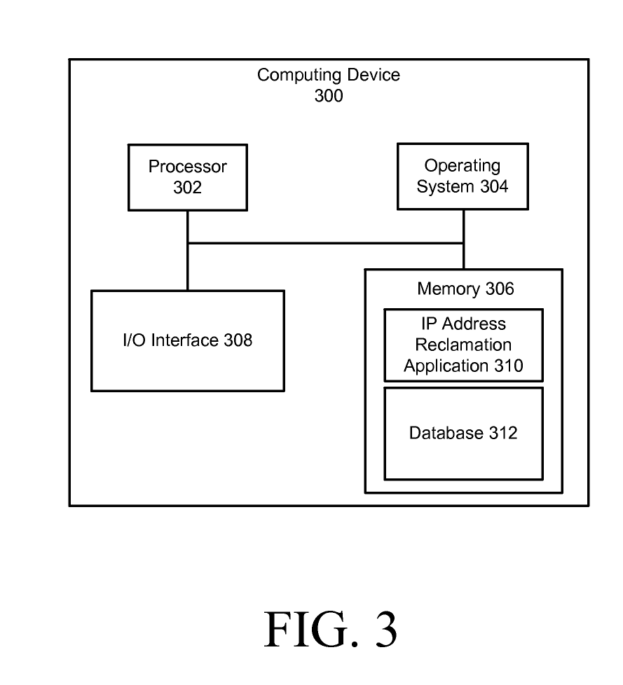

FIG. 3 is a diagram of an example computer system 300 in accordance with at least one implementation. The computer 300 includes a processor 302, operating system 304, memory 306 and I/O interface 308. The memory 306 can include an IP address reclamation application 310 and a database 312 (e.g., for storing IP address information, DHCP information, client information, timer information or the like).

In operation, the processor 302 may execute the application 310 stored in the memory 306. The application 310 can include software instructions that, when executed by the processor, cause the processor to perform operations for reclaiming IP addresses from disassociated wireless clients in accordance with the present disclosure (e.g., performing one or more of steps 202-212).

The application program 310 can operate in conjunction with the database 312 and the operating system 304.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for reclaiming DHCP leased IP address from disassociated clients in a WLAN.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A method comprising:
detecting, at a wireless access point, that a client has lost connectivity with the wireless access point;
determining, at the wireless access point, whether the client released its leased IP address;
transmitting, from the wireless access point to a wireless controller, a message indicating the client has lost connectivity and an indication of whether the client released its leased IP address;
starting an IP address reclaim timer at the wireless controller;
when the IP address reclaim timer expires, sending an instruction message to a wireless switching point instructing the wireless switching point to send an IP address release message on behalf of the client; and
sending, from the wireless switching point, the IP address release message on behalf of the client.

2. The method of claim 1, further comprising stopping the IP address reclaim timer when the client reconnects, before the IP address reclaim timer expires, to the network at a same or different wireless access point than the client was previously connected to.

3. The method of claim 1, wherein the IP address is a DHCP leased IP address.

4. The method of claim 1, wherein the wireless access point performs the operations of the wireless switching point.

5. A system comprising one or more processors configured to perform operations including:
detecting, at a wireless access point, that a client has lost connectivity with the wireless access point;
determining, at the wireless access point, whether the client released its leased IP address;
transmitting, from the wireless access point to a wireless controller, a message indicating the client has lost connectivity and an indication of whether the client released its leased IP address;
starting an IP address reclaim timer at the wireless controller;
when the IP address reclaim timer expires, sending an instruction message to a wireless switching point instructing the wireless switching point to send an IP address release message on behalf of the client; and
sending, from the wireless switching point, the IP address release message on behalf of the client.

6. The system of claim 5, wherein the operations further comprise stopping the IP address reclaim timer when the client reconnects, before the IP address reclaim timer expires, to the network at a same or different wireless access point than the client was previously connected to.

7. The system of claim 5, wherein the IP address is a DHCP leased IP address.

8. The system of claim 5, wherein the wireless access point performs the operations of the wireless switching point.

9. A nontransitory computer readable medium having stored thereon software instructions that, when executed by one or more processors, cause the one or more processors to perform operations including:
detecting, at a wireless access point, that a client has lost connectivity with the wireless access point;
determining, at the wireless access point, whether the client released its leased IP address;
transmitting, from the wireless access point to a wireless controller, a message indicating the client has lost connectivity and an indication of whether the client released its leased IP address;
starting an IP address reclaim timer at the wireless controller;
when the IP address reclaim timer expires, sending an instruction message to a wireless switching point instructing the wireless switching point to send an IP address release message on behalf of the client; and
sending, from the wireless switching point, the IP address release message on behalf of the client.

10. The nontransitory computer readable medium of claim 9, wherein the operations further comprise stopping the IP address reclaim timer when the client reconnects, before the IP address reclaim timer expires, to the network at a same or different wireless access point than the client was previously connected to.

11. The nontransitory computer readable medium of claim 9, wherein the IP address is a DHCP leased IP address.

12. The nontransitory computer readable medium of claim 9, wherein the wireless access point performs the operations of the wireless switching point.
